(19) United States
(12) Patent Application Publication
(10) Pub. No.: US 2026/0249729 A1
(43) Pub. Date: Aug. 27, 2026

(54) METHOD OF CHARGING VEHICLE BATTERY IN CONSIDERATION OF CHARGING PERFORMANCE AND EFFICIENCY, AND ELECTRIFIED VEHICLE USING THE SAME

(71) Applicants: Hyundai Motor Company, Seoul (KR); Kia Corporation, Seoul (KR)

(72) Inventors: Joong Woo Lee, Hwaseong-si (KR); Seung Myun Chung, Hwaseong-si (KR); Jung Woo Seo, Hwaseong-si (KR); Won Woo Suh, Hwaseong-si (KR); Bong Uk Bae, Hwaseong-si (KR); Jin Gyu Lim, Hwaseong-si (KR); Seo Youn Jun, Hwaseong-si (KR); Yoh Han Kim, Hwaseong-si (KR); Tae Geun Jeong, Hwaseong-si (KR)

(21) Appl. No.: 19/279,547

(22) Filed: Jul. 24, 2025

(30) Foreign Application Priority Data
Feb. 27, 2025 (KR) 10-2025-0026044

(51) Int. Cl. B60L 53/62; B60L 58/26; B60L 58/27

(52) U.S. Cl. CPC B60L 53/62; B60L 58/26; B60L 58/27; B60L 2240/545

(57) ABSTRACT

A method of charging a vehicle battery, and an electrified vehicle or vehicle system configured to perform such method, where the method can include determining, in charging the vehicle battery with charging power provided by an external charger, a control target temperature range for the vehicle battery based on a set charging mode among a plurality of charging modes, which differ in charging environment information, battery condition information, charging efficiency, and charging performance (e.g., by a first controller), and heating or cooling the battery based on the determined control target temperature range (e.g., controlled by the first controller).

### CROSS-REFERENCE TO RELATED APPLICATIONS

This application claims priority from Korean Patent Application No. 10-2025-0026044, filed on, February 27, 2025, in the Korean Intellectual Property Office, the disclosure of which is incorporated herein by reference in its entirety.

### TECHNICAL FIELD

The present disclosure relates to a method of charging a vehicle battery.

### BACKGROUND

With the increasing popularity of electrified vehicles, charging performance and charging efficiency are emerging as important product indicators in the electrified vehicles. Such characteristics are important because better charging performance shortens charging time, and better charging efficiency reduces charging cost.

The charging performance and charging efficiency may vary depending on a control strategy of a current that flows from a charger to a battery or a thermal management control strategy of the battery. In this regard, development has been mainly focused on improving the charging performance of the battery in the electrified vehicle. As a result, a strategy has been employed to maximize battery thermal management for allowing the highest current to flow from the charger to the battery.

However, in a case where the battery thermal management is used to allow the highest current to flow from the charger to the battery, energy consumed for the battery thermal management increases, thereby increasing battery charging cost. In other words, in this case, because charging efficiency decreases, there is a trade-off between charging performance and charging efficiency. Therefore, a method of efficiently charging a battery using a charging mode in which a driver's needs are reflected is considered.

The above information disclosed in this background section is only for understanding of a technical background of the disclosure, and therefore, should not be interpreted to disclose prior art that is already publicly known, available, or in use.

### SUMMARY

The present disclosure relates to a method of charging a vehicle battery in consideration of charging performance and efficiency according to a driver’s request and an electrified vehicle using the same.

Therefore, the present disclosure has been made in view of the above problems, and an embodiment of the present disclosure can provide a method of efficiently charging a vehicle battery in consideration of charging performance and efficiency according to a driver's request.

Various advantages are not limited to the above-mentioned advantages, and other advantages not mentioned may be clearly understood by those skilled in the art from the following description.

In accordance with an embodiment of the present disclosure, the above and other advantages can be accomplished by the provision of a method of charging a vehicle battery, which can include: determining, in charging the vehicle battery with charging power provided by an external charger, a control target temperature range for the vehicle battery during charging based on a currently set charging mode among a plurality of charging modes, which differ in charging environment information, battery condition information, charging efficiency and charging performance, by a first control unit; and heating or cooling the battery based on the determined control target temperature range, by the first control unit.

For example, the battery condition information may include information on at least one of a state of charge (SoC) of the battery, a temperature of the battery, or a limit temperature based on a temperature rise during driving after battery charging.

For example, the heating the battery by the first control unit may include controlling, in a case where a current temperature of the battery is equal to or lower than a heating target temperature that is a lower limit value of temperature in the control target temperature range, the temperature of the battery to be increased to the heating target temperature, by the first control unit.

For example, the controlling the temperature of the battery to be increased to the heating target temperature may include operating a battery heater by a second control unit that manages the battery.

For example, the cooling the battery by the first control unit may include controlling, in a case where a current temperature of the battery is equal to or higher than a cooling target temperature that is an upper limit value of temperature in the control target temperature range, the temperature of the battery to be lowered to the cooling target temperature, by the first control unit.

For example, the controlling the temperature of the battery to be lowered to the cooling target temperature may include controlling an air conditioning system, by a third control unit that controls the air conditioning system, to lower the temperature of the battery.

For example, the charging mode may include a first mode in which the charging performance is maximized, a second mode in which the charging efficiency is maximized, a third mode that has lower charging performance than the first mode and lower charging efficiency than the second mode, and a fourth mode in which a driver arbitrarily sets the charging performance and the charging efficiency.

For example, the charging environment information may include information on a power capacity of the external charger.

For example, the method may further include controlling charging current transmitted to the battery according to the charging mode, by a fourth control unit that controls a charging process by communication with the external charger.

In accordance with an embodiment of the present disclosure, the above and other advantages may be accomplished by the provision of an electrified vehicle, which can include: a battery; and a first control unit that determines, in charging the battery with charging power provided by an external charger, a control target temperature range for the battery during charging based on a currently set charging mode among a plurality of charging modes, which differ in charging environment information, battery condition information, charging efficiency and charging performance.

For example, the battery condition information may include information on at least one of an SoC of the battery, a temperature of the battery, or a limit temperature at a point at which charging is completed based on a temperature rise during driving after battery charging.

For example, the first control unit may control, in a case where a current temperature of the battery is equal to or lower than a heating target temperature that is a lower limit value of temperature in the control target temperature range, the temperature of the battery to be increased to the heating target temperature.

For example, the electrified vehicle may further include a second control unit that manages the battery and controls a battery heater, in which the first control unit operates the battery heater through the second control unit.

For example, the first control unit may control, in a case where a current temperature of the battery is equal to or higher than a cooling target temperature that is an upper limit value of temperature in the control target temperature range, the temperature of the battery to be lowered to the cooling target temperature.

For example, the electrified vehicle may further include a third control unit that controls an air conditioning system, in which the first control unit controls the air conditioning system, by the third control unit, to lower the temperature of the battery.

For example, the charging mode may include a first mode in which the charging performance is maximized, a second mode in which the charging efficiency is maximized, a third mode that has lower charging performance than the first mode and lower charging efficiency than the second mode, and a fourth mode in which a driver arbitrarily sets the charging performance and the charging efficiency.

For example, the charging environment information may include information on a power capacity of the external charger.

For example, the electrified vehicle may further include a fourth control unit that communicates with the external charger and controls charging current transmitted to the battery according to the charging mode.

### BRIEF DESCRIPTION OF THE DRAWINGS

The above and other features and advantages of example embodiments of the present disclosure can be more clearly understood from the following detailed description taken in conjunction with the accompanying drawings, in which:

FIG. 1 is a diagram showing an example of an environmental configuration for vehicle battery charging according to an embodiment of the present disclosure;

FIG. 2 is a diagram showing an example of a process of performing thermal management of a battery at a control target temperature corresponding to a charging mode by a vehicle control unit (VCU) according to an embodiment of the present disclosure;

FIG. 3 is a diagram showing an example of a process of controlling charging current transmitted from an external charger to a battery according to a charging mode by a vehicle charging management system (VCMS) according to an embodiment of the present disclosure;

FIG. 4 is a diagram showing an example of a process of managing heat of a battery during battery charging in a vehicle according to an embodiment of the present disclosure;

FIG. 5 is a diagram showing an example of a process of creating a 3D map according to an embodiment of the present disclosure;

FIG. 6 is a diagram showing an example of selecting a charging mode through a mobile phone according to an embodiment of the present disclosure;

FIG. 7 is a diagram showing an output example of a screen for selecting a charging mode through a display by an audio, video, navigation, and telematics (AVNT) terminal according to an embodiment of the present disclosure;

FIG. 8 is a diagram showing an output example of a custom charging mode on a display of an AVNT terminal according to an embodiment of the present disclosure; and

FIG. 9 is a diagram showing an output example of an estimated charging time and charging cost after selecting a charging mode on a display according to an embodiment of the present disclosure.

### DETAILED DESCRIPTION OF ILLUSTRATIVE EMBODIMENTS

Reference will now be made in detail to example embodiments of the present disclosure, which are illustrated in the accompanying drawings. Wherever possible, the same reference numbers will be used throughout the drawings to refer to the same or like parts. In describing the example embodiments, detailed descriptions of related known technologies can be omitted. It can be understood that the accompanying drawings are given hereinafter by way of illustration and are not necessarily limitative of the disclosure, and the present disclosure is intended to cover various alternatives, modifications, equivalents, and other embodiments, within the spirit and scopes of the present disclosure and as defined by the appended claims.

It can be understood that, although the terms “first”, “second”, etc., may be used herein to describe various elements, these elements are not necessarily limited by these terms. These terms can be used merely to distinguish one element from another.

It can be understood that, when an element is “connected” or “coupled” to another element, it may be directly connected or coupled to the other element, or may be indirectly connected or coupled to the other element with a different element being interposed therebetween. In contrast, when an element is “directly connected” or “directly coupled” to another element, then there is typically no intervening element therebetween.

As used herein, the singular forms “a”, “an”, and “the” can be intended to include the plural forms as well, unless the context clearly indicates otherwise.

It can be understood that the terms “comprise”, “include”, and “have” used herein merely specify the presence of stated features, numbers, steps, operations, components, parts, or combinations thereof, but do not preclude the presence or addition of one or more other features, numbers, steps, operations, components, parts, or combinations thereof.

Terms, such as motor control unit (MCU) and a hybrid control unit (HCU), can be terms commonly used in the automotive industry, and a given control unit may include a communication device that communicates with other control units or sensors, a memory that stores an operating system or logic instructions and input/output information, and one or more processors that perform necessary determinations, operations, and the like, any of, any combination of, or all of which may be in plural or may include plural components thereof, for example.

In an embodiment of the present disclosure, a method of charging a vehicle battery in consideration of charging performance and efficiency can be provided. Considering charging performance can be an estimated time necessary to fully charge a current battery or an estimated time necessary to charge the battery to a specific level in consideration of a current state of a vehicle battery and a power capacity of a charger. Considering charging efficiency can be an estimated cost necessary to charge the battery until a full level.

The relationship between the charging performance and charging efficiency of the vehicle battery can be as follows. In a case where the charging performance is improved, the amount of energy consumed for thermal management of the battery increases, thereby resulting in higher charging cost, which may lead to poorer charging efficiency. On the other hand, in a case where the battery charging performance deteriorates, the amount of energy consumed for thermal management of the battery decreases, thereby resulting in higher charging cost, which may lead to better charging efficiency. Thus, there may be a trade-off between charging performance and charging efficiency. In an embodiment of the present disclosure, an optimal battery charging method in consideration of both the charging performance and charging efficiency can be provided.

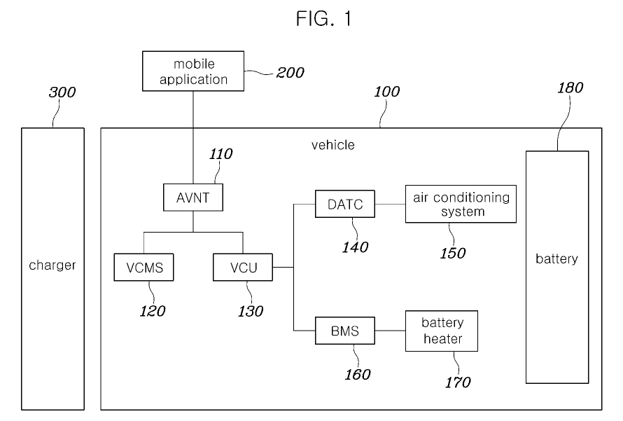

FIG. 1 is a diagram showing an example of an environmental configuration for vehicle battery charging according to an embodiment of the present disclosure.

Referring to FIG. 1, components for charging a vehicle battery according to an embodiment of the present disclosure can include a vehicle 100, a mobile application 200, and a charger 300.

The vehicle 100 may include an audio, video, navigation and telematics (AVNT) terminal 110, a vehicle charging management system (VCMS) 120, a vehicle control unit (VCU) 130, a dual automatic temperature controller (DATC) 140, an air conditioning system 150, a battery management system (BMS) 160, a battery heater 170, and a battery 180, any of, any combination of, or all of which may be in plural or may include plural components thereof. The AVNT terminal 110, the VCMS 120, the VCU 130, the DATC 140 and the BMS 160 may perform information transmission/reception through a controller area network (CAN) communication. The CAN communication can be a communication protocol for data exchange between control units that share a bus, which is widely used for in-vehicle communication. The CAN communication is merely an example and an embodiment is not necessarily limited thereto, and any other communication protocol such as CAN-FD (flexible data rate) and Ethernet capable of performing control period data exchange may be used, for example.

Hereinafter, the example components will be described in more detail.

The AVNT terminal 110 may output various information related to the vehicle (e.g., current location of the vehicle, in-vehicle air conditioning system information, battery condition information, and the like), or may manage and control functions related to safety of the vehicle and comfort of a driver. In an embodiment of the present disclosure, the AVNT terminal 110 may present vehicle battery charging modes to the driver through a display. Based on one of the presented charging modes being selected, the AVNT terminal 110 may output an estimated charging time and charging cost according to the selected charging mode.

The charging modes may include a performance mode for maximizing charging performance, an eco-mode for maximizing charging efficiency, a smart mode for providing an optimized charging method given a current vehicle battery condition in consideration of charging performance and charging efficiency, and a custom mode for allowing a driver to select charging performance and charging efficiency, for example. The smart mode may be substantially the same as the eco mode or a smart mode depending on the battery condition, for example. The smart mode may have higher charging performance and lower charging efficiency than the eco mode, or may have higher charging efficiency and lower charging performance than the performance mode. Classifications, names, and the like of the above-mentioned modes are examples, and the respective modes may have different classifications, names, and the like in implementation.

Maximizing the charging performance can be minimizing a charging time and increasing the amount of energy to manage battery heat and the amount of current flowing from the charger, for example. Maximizing the charging efficiency can be reducing the amount of energy to manage battery heat, the amount of current flowing from the charger, and decreasing the cost to charge as much as possible, for example.

The VCMS 120 may perform communication with an external charger, determination of charging parameters, and the like, for charging the vehicle battery using external power. In an embodiment of the present disclosure, the VCMS 120 may receive information on the power capacity of the charger from the charger 300 when charging the battery, and transmit the information to the control unit that requests the information during the charging process. For example, the information on the power capacity of the charger may be used along with information on the current battery condition when determining whether the VCU 130 should perform either heating or cooling control in a case where the VCU 130 controls a heating or cooling control unit.

The VCU 130 may function as a higher-level control unit that performs overall control of a power electric (PE) system, including driving of an electrified vehicle. In an embodiment of the present disclosure, to manage battery heat when charging the battery with external power, the VCU 130 may determine whether to perform either heating or cooling control by comprehensively considering information on the power capacity of the charger, the current charging state and temperature of the battery, and the charging mode.

The DATC 140 may control the air conditioning system 150. For example, based on lowering the temperature in a vehicle cabin, or based on cooling the PE system including the battery at the request of the VCU 130, the DATC 140 may operate the air conditioning system 150.

The air conditioning system 150 can control the temperature and humidity in the vehicle cabin. In an embodiment of the present disclosure, the air conditioning system 150 may include a radiator, a water pump, a coolant, a heat exchanger, and the like, as devices for performing cooling control, any of, any combination of, or all of which may be in plural or may include plural components thereof.

The BMS 160 may monitor the battery condition in the electric vehicle, manage the safety of the battery, and provide various information on the battery condition (e.g., current temperature, SoC, and the like, of the battery). In an embodiment of the present disclosure, the BMS 160 may provide information on a current SoC and a current temperature of the battery during battery charging, to the VCU 130.

The battery heater 170 can increase the temperature of the battery. The BMS 160 may increase the temperature of the battery by controlling the battery heater 170 according to a battery heating control command from the VCU 130.

On the other hand, based on the AVNT terminal 110 supporting a connected car service, the AVNT terminal 110 may receive mode selection information according to an embodiment through the mobile application 200 running on a mobile terminal, etc. Alternatively, the driver may select the charging mode directly through the AVNT terminal 110, for example.

The charger 300 may be an electric vehicle charger (e.g., electric vehicle supply equipment or EVSE). In an embodiment of the present disclosure, a DC fast charger can be used for example, which is not necessarily limiting.

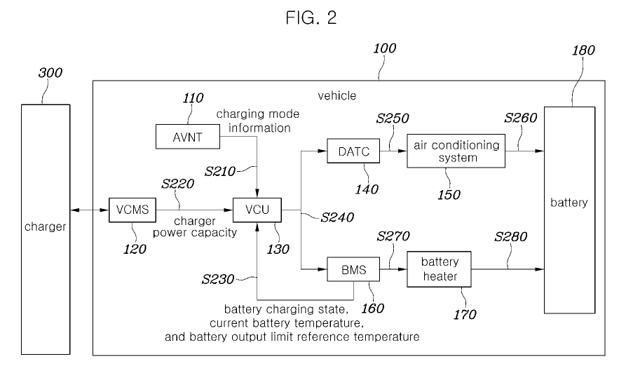

FIG. 2 shows an example of a process of performing thermal management of a battery at a control target temperature corresponding to a charging mode by the VCU 130 according to an embodiment of the present disclosure.

Referring to FIG. 2, the AVNT terminal 110 may transmit information on the charging mode selected by the driver to the VCU 130 (operation S210). Based on the vehicle 100 being connected to the charger 300, the VCMS 120 may receive information on the power capacity of the charger 300 from the charger 300 and transmit the information to the VCU 130 (operation S220). The BMS 160 may transmit information on the SoC and the current temperature of the battery 180 to the VCU 130 (operation S230).

The information received by the VCU 130 may serve as information used for setting a target temperature limit range in the VCU 130. More specifically, the VCU 130 may determine the target temperature limit range corresponding to the information received from the VCMS 120 and the BMS 160 based on a pre-stored parameter map. The parameter map may be obtained by configuring, in a set, selected, or predetermined format, result values of a plurality of target limit temperature ranges that may occur in consideration of various combinations of the SoC of the vehicle battery, the current temperature of the vehicle battery, and the power capacity of the charger, which are information that can be used for determining a heating target temperature and a cooling target temperature. In a case where three or more factors are taken into account in the determination of the target limit temperature range according to an embodiment of the present disclosure, a plurality of parameter maps may be prepared in a 3D map form.

The target limit temperature range may include a cooling start temperature corresponding to an upper limit and a heating target temperature corresponding to a lower limit. The target limit temperature range may be an optimal temperature range of the battery, determined to satisfy the currently set mode based on the information received by the VCU 130, and the VCU 130 may control the cooling control unit or the heating control unit so that the battery can be maintained within the target limit temperature range.

Thus, the VCU 130 may derive a result value corresponding to the selected charging mode among the result values from the 3D map to determine whether to perform either cooling control or heating control (operation S240).

The cooling control can be performed as follows. The VCU 130 may issue a cooling control command to the DATC 140 to allow the DATC 140 to control the air conditioning system 150 based on the current battery temperature reaching the cooling start temperature. The DATC 140 may control cooling through the air conditioning system 150 based on the DATC 140 receiving the control command from the VCU 130 (operation S250). The air conditioning system 150 may be controlled by the DATC 140 to lower the temperature of the battery (operation S260).

The heating control is performed as follows. Based on the current battery temperature being lower than the heating target temperature, the VCU 130 may issue a heating control command to the BMS 160 so that the BMS 160 can control the battery heater 170. Based on the BMS 160 receiving the heating control command from the VCU 130, the BMS 160 may perform heating control through the battery heater 170 (operation S270). The battery heater 170 may be controlled by the BMS 160 to increase the temperature of the battery (operation S280).

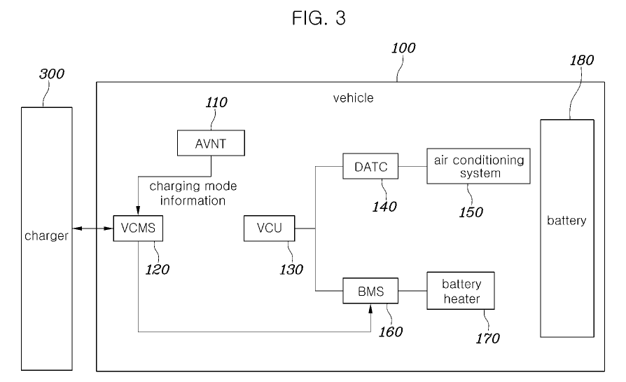

FIG. 3 is a diagram showing an example of a process of controlling charging current transmitted from an external charger to a battery according to a charging mode by a VCMS according to an embodiment of the present disclosure.

Referring to FIG. 3, based on the vehicle 100 and charger 300 being connected, the VCMS 120 may receive information on the power capacity from the charger 300. Based on the information on the power capacity of the charger 300, the BMS 160 may calculate an amount of current flowing from the charger 300 in consideration of battery condition information, such as a maximum power, a current temperature, and an SoC of the battery 180, and may adjust the charger 300 according to the calculated value to control the amount of current flowing into the battery.

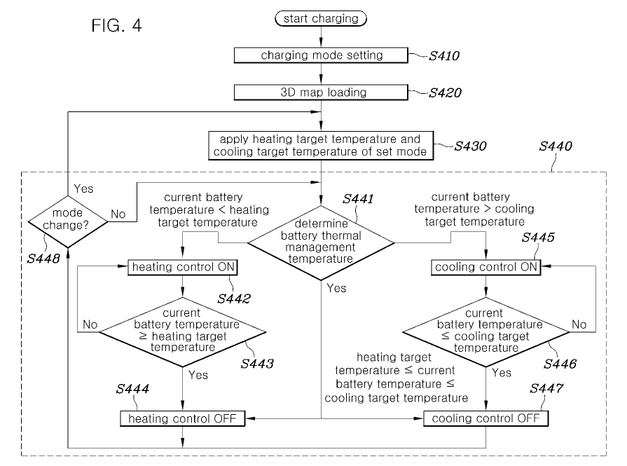

FIG. 4 is a diagram showing an example of a process of managing heat of a battery during battery charging in a vehicle according to an embodiment of the present disclosure.

Referring to FIG. 4, first, a charging mode may be set by the driver using the mobile application 200 and/or using a display in the vehicle (operation S410). Information on the set charging mode may be transmitted to the VCU 130.

The VCU 130 may refer to a 3D map pre-stored in memory (operation S420). The VCU 130 may confirm information on the power capacity of the charger transmitted from the VCMS 120 and the current temperature and SoC of the vehicle battery transmitted from the BMS 160. Then, the VCU 130 may read the information on the set charging mode, and may set the heating target temperature and/or cooling target temperature corresponding to the set charging mode based on the previously read 3D map and the confirmed information on the battery condition and the charger power capacity (operation S430).

The heating target temperature and/or cooling target temperature set in the VCU 130 may be a reference temperature to be compared with the current battery temperature in the battery thermal management. Thus, the VCU 130 may perform heating or cooling control by applying the set control target temperature range (operation S440).

The specific process (operation S440) of performing cooling or heating control by the VCU 130 can be as follows. First, the VCU 130 may compare the current battery temperature with the control target temperature range (operation S441). In a case where the current battery temperature is lower than the heating target temperature, the VCU 130 may activate the heating control (operation S442). In a case where the current battery temperature continues to be lower than the heating target temperature, the activated heating control may be maintained, and in a case where the current battery temperature becomes equal to or higher than the heating target temperature, the heating control may be deactivated (operation S443).

In a case where the current battery temperature is higher than the cooling target temperature, the VCU 130 may activate the cooling control (operation S445). In a case where the current battery temperature continues to be higher than the cooling target temperature, the activated cooling control may be maintained, and in a case where the current battery temperature becomes equal to or lower than the cooling target temperature, the cooling control may be deactivated (operation S446).

In a case where the current battery temperature is equal to or higher than the heating target temperature, or is equal to or lower than the cooling control target, the VCU 130 can deactivate the heating control or cooling control, respectively (operations S444, S447).

In a case where the driver changes the charging mode during charging (Yes in operation S448), the VCU 130 may re-determine the heating target temperature and cooling target temperature corresponding to the changed charging mode based on the 3D map (operation S430), and may perform battery thermal management again based on the re-determined heating target temperature and cooling target temperature (operation S440). In a case where the charging mode is not changed (No in operation S448), the VCU 130 may perform heating or cooling control by comparing the current battery temperature with the already determined heating target temperature and/or cooling target temperature (operation S440).

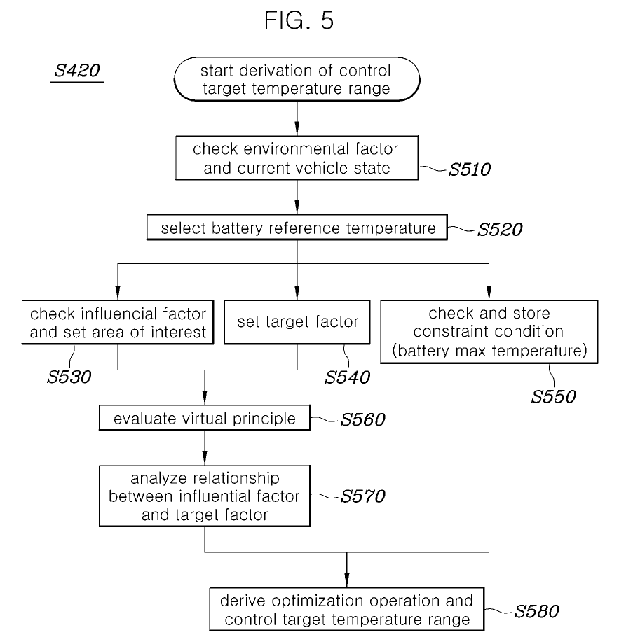

FIG. 5 shows an example of a process of creating a 3D map according to an embodiment of the disclosure. In an embodiment of the present embodiment, the process shown in FIG. 5 can be performed in a lab environment of a vehicle manufacturer, for example.

Referring to FIG. 5, one of various environmental factors and a current vehicle state may be selected or arbitrarily set (operation S510). The environmental factors may include a charger power capacity, and the current vehicle state may include a current temperature of the vehicle battery and an SoC of the battery when charging is started.

Then, a battery reference temperature of the battery may be selected based on the environmental factor and the current state of the vehicle that are selected or arbitrarily set (operation S520). The battery reference temperature may include a point corresponding to a temperature axis in a map, and may be set as a range boundary value in a case where an arbitrarily set battery temperature exceeds an intended temperature axis range on the map.

Based on the environmental factors, the current vehicle state and the selected battery reference temperature, the charger power capacity, the battery reference temperature, and a current SoC of the battery that affect battery charging performance and efficiency may be set (operation S530). A target factor setting step may include a selected or arbitrarily defined step of setting a charging time that represents the charging performance and the charging efficiency that represents a charging cost as information for charging mode setting (operation S540). A constraint condition may include information on a limit temperature at a point at which charging is completed based on a temperature rise during driving after battery charging, which may be derived from the current temperature and the SoC of the battery (operation S550).

Information on the charger power capacity, the battery reference temperature, and the current SoC of the battery and a relationship between the charging time and the charging efficiency set as target factors may be analyzed through design of experiments (operations S560, S570). A plurality of target limit temperature ranges to be derived may be result values according to the selected or arbitrarily set environmental factors and current vehicle state. Thus, by analyzing target limit temperature ranges for various environmental factors and current vehicle states, the target limit temperature range in each of various situations may be derived.

Through a relationship between the derived relationship and the previously determined constraint condition, an actually available optimal control target temperature range may be derived, and these values may form the 3D map (operation S580).

As described above, the process shown in FIG. 5 can be performed in the lab environment, but this is an example and not necessarily limiting. For example, the process shown in FIG. 5 may be performed in a vehicle environment with appropriate modifications. For example, the process of creating the 3D map shown in FIG. 5 may be performed by a vehicle control unit such as the VCU 130, and in this case, the selected or arbitrarily set values may be replaced by values detected or determined according to an actual current environment of the vehicle.

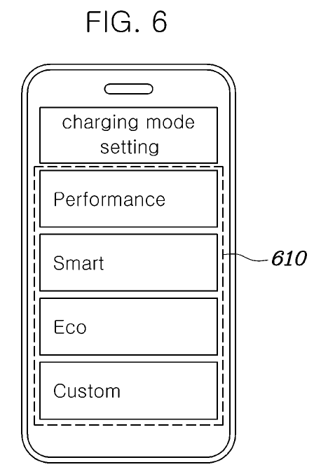

FIG. 6 is a diagram showing an example of selecting a charging mode through a mobile phone according to an embodiment of the present disclosure.

Referring to FIG. 6, the charging mode may be selected through a mobile terminal in which the mobile application 200 is installed. Information on the selected charging mode may be transmitted to the AVNT terminal 110 of the vehicle through a connected car service server, etc., to thereby remotely select the battery charging mode.

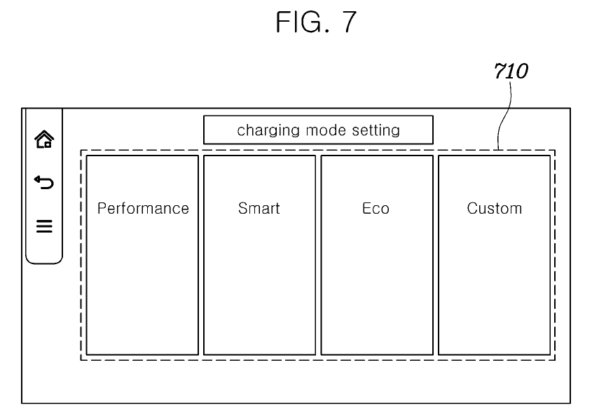

FIG. 7 shows an example in which the AVNT terminal 110 selects a charging mode through a display according to an embodiment of the present disclosure.

Similar to the method for selecting the charging mode through the mobile application 200, a menu for selecting the charging mode may be displayed through a set, selected, or predetermined menu operation on the AVNT terminal 110, as shown in FIG. 7.

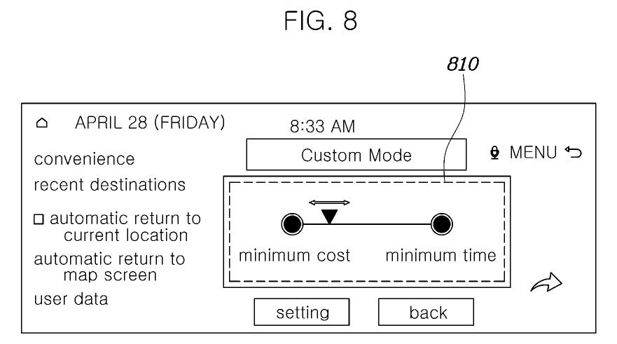

FIG. 8 shows an output example of a custom charging mode on a display of the AVNT terminal 110 according to an embodiment of the present disclosure.

FIG. 8 shows an example such that the custom mode for allowing a driver to set charging performance and charging efficiency arbitrarily on the menu screen as shown in FIG. 7 is selected.

Referring to FIG. 8, in the custom mode, the driver may set whether to give more weight to the charging efficiency (i.e., minimum charging cost) or the charging performance (i.e., minimum charging time) when charging by moving a cursor on a screen left or right. That is, a driver who prioritizes charging performance may set the charging time to the minimum, and a driver who prioritizes charging efficiency may set the charging cost to the minimum.

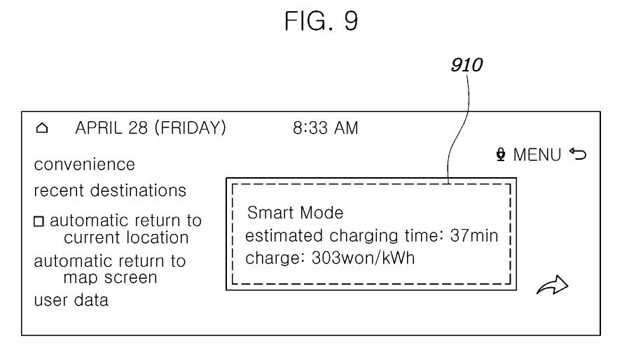

FIG. 9 is a diagram showing an output example of an estimated charging time and a charging cost after selecting a charging mode on a display according to an embodiment of the present disclosure.

Referring to FIG. 9, a selected charging mode may be displayed on the first line, and an estimated charging time may correspond to a remaining time until the battery is fully charged. The charging cost may be expressed as a charging cost per kilowatt-hour. This information provision screen is merely an example, and those skilled in the art can understand that various variations are possible in the location, display unit, and format of each information.

According to an embodiment of the present disclosure, because battery thermal management can be performed during charging based on the heating target temperature and/or cooling target temperature corresponding to a selected charging mode, it can be possible to efficiently charge the battery according to a user's desired charging mode.

An embodiment of the present disclosure may be implemented as a computer-readable medium or storage medium on which a program corresponding to a method embodiment of the present disclosure is written. The computer-readable medium can include any or all kinds of recording devices in which computer-readable data is stored. The computer-readable medium can include a hard disk drive (HDD), a solid state drive (SSD), a silicon disk drive (SDD), a ROM, a RAM, a CD-ROM, a magnetic tape, a floppy disk, an optical data storage system, or any combination thereof, for example. For example, a storage medium can store computer-readable instructions that, when executed by at least one processor, can enable the at least one processor to control and/or perform part of or all of a method embodiment of the present disclosure.

Using an embodiment of the present disclosure, it can be possible to provide a method of efficiently charging a vehicle battery in consideration of charging performance and efficiency according to a driver’s request.

The advantages obtained using an embodiment of the present disclosure are not necessarily limited to the above-mentioned advantages, and other advantages not mentioned may be understood by those skilled in the art to which the present disclosure belongs from the description.

Although example embodiments of the present disclosure have been disclosed for illustrative purposes, those skilled in the art can appreciate that various modifications, additions, and substitutions are possible, without departing from the scopes and spirit of the disclosure as disclosed, the accompanying claims, and equivalents thereof.

What is claimed is:

1. A method of charging a vehicle battery comprising:
determining a control target temperature range for the vehicle battery based on charging the vehicle battery with an external charger and based on a set charging mode among a plurality of charging modes, wherein the plurality of charging modes differ in charging environment information, battery condition information, charging efficiency, and charging performance; and
heating or cooling the vehicle battery based on the determining of the control target temperature range.

2. The method according to claim 1, wherein the battery condition information comprises information on at least one of a state of charge of the vehicle battery, a battery temperature of the vehicle battery, or a limit temperature based on a temperature rise.

3. The method according to claim 2, wherein the heating of the vehicle battery comprises controlling, based on the battery temperature of the vehicle battery being equal to or lower than a heating target temperature that is a lower limit value of temperature in the control target temperature range, the battery temperature of the vehicle battery to be increased to the heating target temperature.

4. The method according to claim 3, wherein the controlling the battery temperature of the vehicle battery to be increased to the heating target temperature comprises operating a battery heater.

5. The method according to claim 2, wherein the cooling of the vehicle battery comprises controlling, based on the battery temperature of the vehicle battery being equal to or higher than a cooling target temperature that is an upper limit value of temperature in the control target temperature range, the battery temperature of the vehicle battery to be lowered to the cooling target temperature.

6. The method according to claim 5, wherein the controlling the battery temperature of the vehicle battery to be lowered to the cooling target temperature comprises controlling an air conditioning system to lower the battery temperature of the vehicle battery.

7. The method according to claim 1, wherein the plurality of charging modes comprises:
a first mode in which the charging performance is maximized;
a second mode in which the charging efficiency is maximized;
a third mode that has lower charging performance than the first mode and lower charging efficiency than the second mode; and
a fourth mode in which a user sets the charging performance and the charging efficiency.

8. The method according to claim 1, wherein the charging environment information comprises information on a power capacity of the external charger.

9. The method according to claim 1, further comprising controlling charging current transmitted to the vehicle battery according to the set charging mode, by controlling a charging process by communication with the external charger.

10. A vehicle comprising:
a battery; and
a first controller configured to determine a control target temperature range for the battery based on charging the vehicle battery with an external charger and based on a set charging mode among a plurality of charging modes, wherein the plurality of charging modes differ in charging environment information, battery condition information, charging efficiency, and charging performance.

11. The vehicle according to claim 10, wherein the battery condition information comprises information on at least one of a state of charge of the battery, a battery temperature of the battery, or a limit temperature based on a temperature rise.

12. The vehicle according to claim 11, wherein the first controller is further configured to control, based on the battery temperature of the battery being equal to or lower than a heating target temperature that is a lower limit value of temperature in the control target temperature range, the battery temperature of the battery to be increased to the heating target temperature.

13. The vehicle according to claim 12, further comprising:
a battery heater; and
a second controller configured to manage the battery and controls the battery heater, wherein the first controller is further configured to operate the battery heater through the second controller.

14. The vehicle according to claim 11, wherein the first controller is further configured to control, based on the battery temperature of the battery being equal to or higher than a cooling target temperature that is an upper limit value of temperature in the control target temperature range, the battery temperature of the battery to be lowered to the cooling target temperature.

15. The vehicle according to claim 14, further comprising:
an air conditioning system; and
a third controller configured to control the air conditioning system, wherein the first controller is further configured to control the air conditioning system through the third controller to lower the temperature of the battery.

16. The vehicle according to claim 10, wherein the plurality of charging modes comprises:
a first mode in which the charging performance is maximized;
a second mode in which the charging efficiency is maximized;
a third mode that has lower charging performance than the first mode and lower charging efficiency than the second mode; and
a fourth mode in which a user sets the charging performance and the charging efficiency.

17. The vehicle according to claim 10, wherein the charging environment information comprises information on a power capacity of the external charger.

18. The vehicle according to claim 10, further comprising a fourth controller configured to communicate with the external charger and to control charging current transmitted to the battery according to the charging mode.

19. A vehicle system comprising:
at least one processor; and
a storage medium storing computer-readable instructions that, when executed by the at least one processor, enable the at least one processor to determine a control target temperature range for a vehicle battery based on a charging operation of charging of the vehicle battery with an external charger and based on a set charging mode among a plurality of charging modes, wherein the plurality of charging modes differ based on a combination of charging environment information, battery condition information, charging efficiency, and charging performance.

20. The vehicle system according to claim 19, wherein the instructions further enable the at least one processor to heat or cool the vehicle battery based on the control target temperature range.
